(19) United States
(12) Patent Application Publication
(10) Pub. No.: US 2007/0188435 A1
(43) Pub. Date: Aug. 16, 2007

(54) Display device with high resolution and slim border structure

(75) Inventors: Yung-Chi Wen, Hsinchu (TW); Chien-Chih Chen, Hsinchu (TW); Jian-Shen Yu, Hsinchu (TW); Kuang-Hsiang Liu, Taichung (TW)

Correspondence Address: BACON & THOMAS, PLLC, 625 SLATERS LANE, FOURTH FLOOR, ALEXANDRIA, VA, 22314, US

(73) Assignee: AU OPTRONICS CORP., Hsin-Chu (TW)

(21) Appl. No.: 11/449,643

(22) Filed: Jun. 9, 2006

(30) Foreign Application Priority Data
Feb. 10, 2006 (TW) 95104586

(51) Int. Cl. G09G 3/36

(52) U.S. Cl. 345/100

(57) ABSTRACT

A display device has a pixel array, a plurality of data buses and a drive circuit. The pixel array has a plurality of data lines and a plurality of pixels. The pixels are electrically coupled to the data lines, and these data lines are electrically coupled to these data buses. The drive circuit receives a plurality of image data sequentially and transforms the image data into pixel voltages, which are outputted from corresponding output terminals.

This application claims the benefit of Taiwan patent application Serial No. 95104586, filed Feb. 10, 2006, the subject matter of which is incorporated herein by reference.

### BACKGROUND OF THE INVENTION

1. Field of the Invention

The invention relates in general to a thin film transistor display device, and more particularly to a liquid crystal display device.

2. Description of the Related Art

Low-temperature polysilicon (LTPS) technology is adopted in the processes of manufacturing a thin film transistor liquid crystal display device, wherein peripheral drive circuits can be integrated on a glass substrate such that the advantages of system integration, product thinning, space miniaturizing and the reduction of the manufacturing cost of external drive ICs are obtained. Because the low-temperature polysilicon technology has the properties of high circuit integration, low power-consumption and low cost, it is widely used in mobile phones, personal digital assistants (PDAs), digital still cameras (DSCs), digital video communication (DVC) camcorders and notebook computers such that these mobile information products become lighter, thinner, and more portable.

FIG. 1 is a schematic illustration showing a conventional liquid crystal display device 100. Referring to FIG. 1, the liquid crystal display device 100 has a lower glass substrate 102, a drive circuit 104 and a pixel array 106. The drive circuit 104, such as a single application specific integrated circuit (ASIC), is integrated on the lower glass substrate 102 using COG manufacturing processes. The drive circuit 104 outputs pixel voltages to a plurality of data lines (not shown) of the pixel array 106 through a plurality of data buses DB. In order to shorten the distance (e.g., the gap L) from the pixel array 106 to the lower glass substrate 102 in a vertical direction, the drive circuit 104 is disposed at a right side of the pixel array 106.

Because the resolution of the liquid crystal display device 100 is getting higher and higher, the number of the data buses DB is also increased. FIG. 2 is a schematic illustration showing a liquid crystal display device with an enlarged circuit area on a lateral side. As shown in FIG. 2, when the resolution of the liquid crystal display device 100 is increased, the number of the data buses DB is also greatly increased. The increase of the number of the data buses DB increases the width L′ of the lateral side of the display device 100 in the vertical direction, wherein the increase of the width is, for example, ΔX, as shown in FIG. 2. Consequently, the size of the end product, such as the digital camera or the mobile phone, is increased, and the product cannot meet the miniaturized trend.

Thus, it is an important subject of the associated industry to prevent the increase of the area of the lateral side of the display panel as the resolution of the display device is increased.

### SUMMARY OF THE INVENTION

It is therefore an object of the invention to provide a liquid crystal display device having a reduced circuit area in which data buses are disposed on a display panel so as to provide a panel of a handheld product having a slim border structure and thus to reduce the size of the handheld product.

The invention achieves the above-identified object by providing a liquid crystal display device which has a pixel array, a plurality of data buses and a drive circuit. The pixel array has a plurality of data lines and a plurality of pixels. The pixels are electrically coupled to the data lines. The data lines are electrically coupled to the data buses. The drive circuit sequentially receives a plurality of image data, and transforms the image data into pixel voltages, which are to be respectively outputted from corresponding output terminals.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Related Art) is a schematic illustration showing a conventional liquid crystal display device.

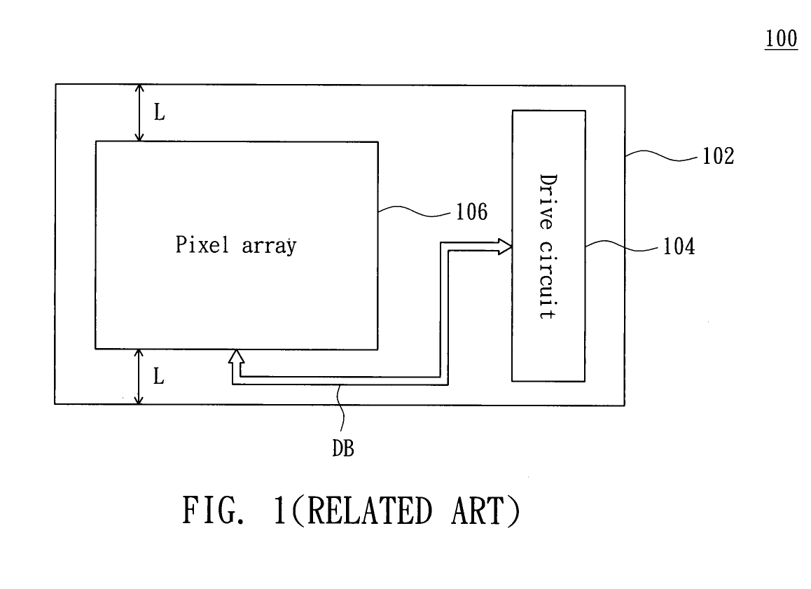

FIG. 2 (Related Art) is a schematic illustration showing a liquid crystal display device with an enlarged circuit area on a lateral side.

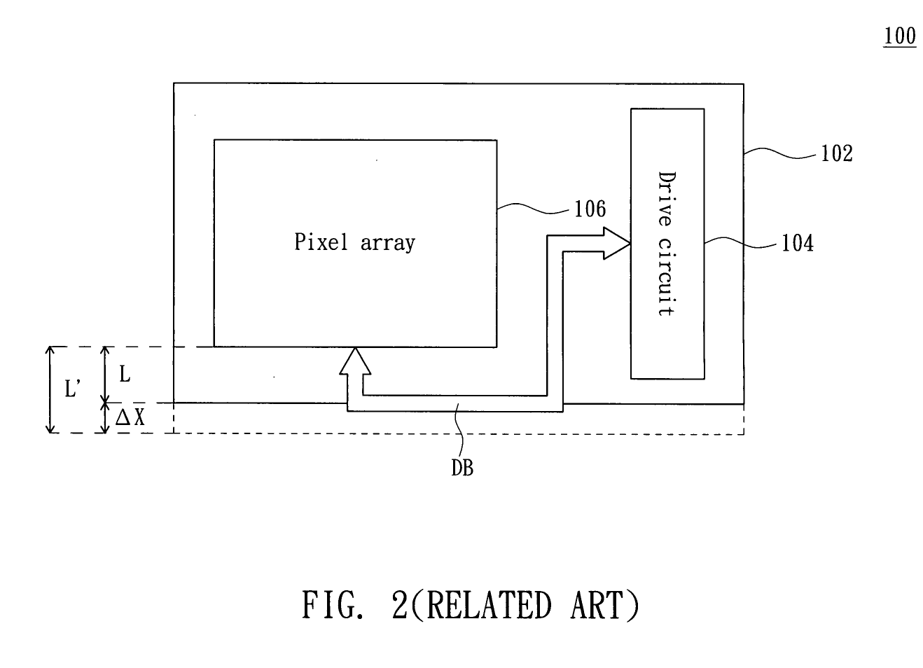

FIG. 3 is a schematic illustration showing a drive circuit according to the invention.

FIG. 4A is a schematic illustration showing a liquid crystal display device according to a first embodiment of the invention.

FIG. 4B is a timing chart showing control signals according to the first embodiment of the invention.

FIG. 5A is a schematic illustration showing a liquid crystal display device according to a second embodiment of the invention.

FIG. 5B is a timing chart showing control signals according to the second embodiment of the invention.

### DETAILED DESCRIPTION OF THE INVENTION

The invention provides a thin film transistor display device having a plurality of data buses respectively disposed at an upper side and a lower side of a pixel array so that the circuit area in which the data buses are disposed on a display panel is reduced. In addition, responding to the manner in which the data buses are disposed at two sides of the pixel array, a new timing control is used to control the order of storing a plurality of image data into latches without changing the original circuit design and the order of receiving the image data.

The output terminals of the conventional data drive circuit sequentially output pixel voltages of a first line, a second line to a last line. For example, the first output terminal outputs the pixel voltage of a first data line, the second output terminal outputs the pixel voltage of a second data line, and the last output terminal outputs the pixel voltage of a last data line. So, the conventional data buses have to be bridged between the data lines and the output terminals according to this design. For example, the data buses have to enable the output terminals to sequentially correspond to the data lines. Consequently, simply disposing the data buses between two sides of the pixel array inevitably causes the cross over phenomenon between some data buses under this conventional design.

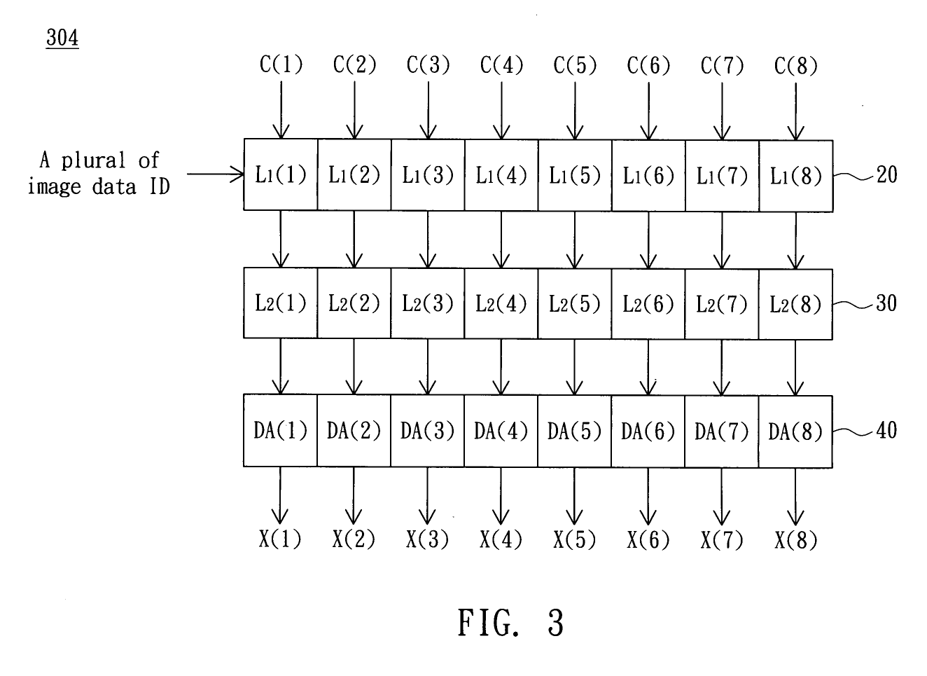

FIG. 3 is a schematic illustration showing a drive circuit 304 according to the invention. The drive circuit 304 has a new timing control to control the order of storing data into latches. The drive circuit 304 has a first latch 20, a second latch 30, a digital-to-analog converter 40 and a plurality of output terminals X. The first latch 20 sequentially receives a plurality of image data ID, such as the image data of the first data line, the second data line to the last data line, and has a plurality of first latch units L₁(1) to L₁(N) corresponding to the number of data lines, wherein N is a positive integer. In this embodiment, N=8. Eight first latch units L₁(1) to L₁(8) respectively receive control signals C(1) to C(8). For example, when the first control signal C(1) is enabled, the received image data ID is stored in the first latch unit L₁(1). After the eight first latch units L₁(1) to L₁(8) have finished storing the image data, the eight image data ID may be stored into the second latch unit L₂. Thus, the second latch 30 corresponding to the first latch 20 also has eight second latch units L₂(1) to L₂(8).

The eight second latch units L₂(1) to L₂(8) are electrically coupled to eight digital-to-analog converting units DA(1) to DA(8) of the digital-to-analog converter 40 respectively. The digital-to-analog converting units DA(1) to DA(8) are electrically coupled to the eight output terminals X(1) to X(8) in order to transform the eight image data ID into the pixel voltages and output the pixel voltages from the eight output terminals X(1) to X(8) respectively.

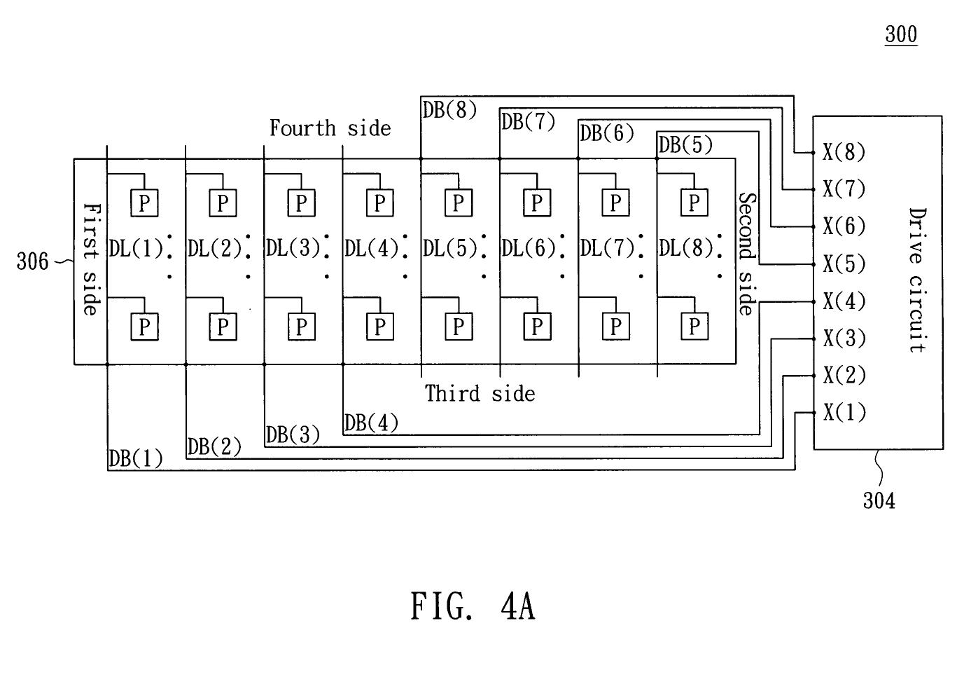

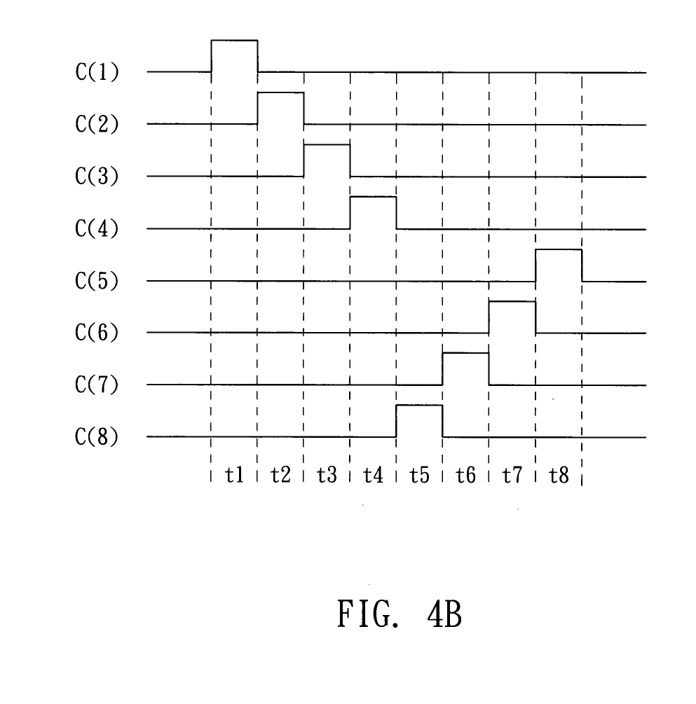

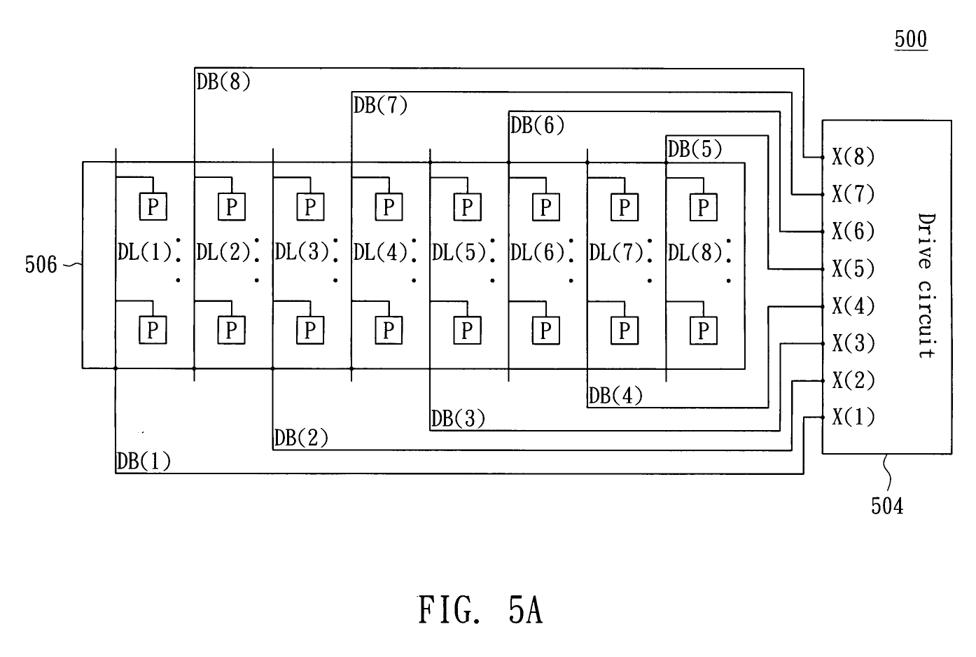

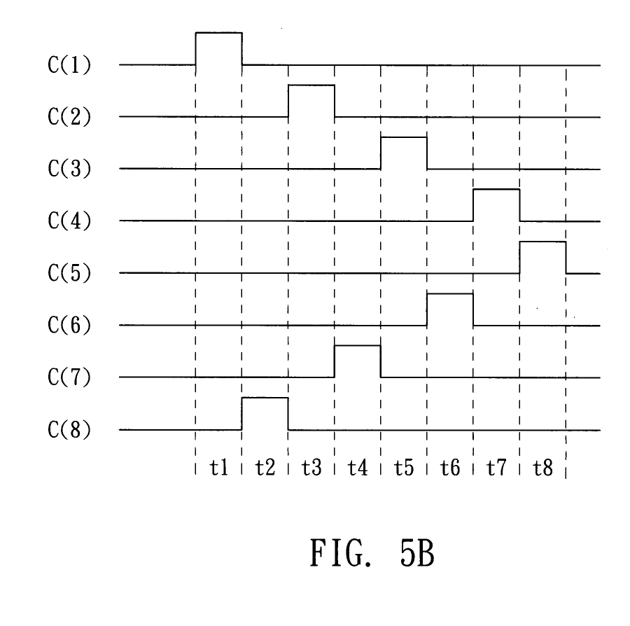

The new timing control of the invention is to determine the order of enabling the control signals C according to the arrangement relationship between the output terminals X and the data lines. That is, the drive circuit 304 respectively stores the image data ID into the corresponding first latch units L₁(1) to L₁(8) according to the arrangement relationship between these output terminals X(1) to X(8) and these data lines DL(1) to DL(M). The data lines DL(1) to DL(M) are depicted in FIGS. 4A and 5A, wherein M is a positive integer. Thereafter, the second latch units L₂(1) to L₂(8) transfer the image data to the digital-to-analog converting units DA(1) to DA(8), which transform the image data into the pixel voltages and transfer the pixel voltages to the output terminals X(1) to X(8), respectively. Consequently, adjusting the timing of enabling the eight control signals C(1) to C(8) can make the data lines receive the correct pixel voltages no matter which data line DL corresponds to the output terminal X. In other words, the connections from the data buses DB (FIGS. 4A and 5A) to the data lines DL and the output terminals X are more flexible.

### First Embodiment

FIG. 4A is a schematic illustration showing a liquid crystal display device according to a first embodiment of the invention. The thin film transistor display device may be, for example, a liquid crystal display device 300. The liquid crystal display device 300, which may be, for example, a display on a mobile phone, a digital camera or a personal digital assistant (PDA), haves the drive circuit 304, a pixel array 306 and a plurality of data buses DB. The pixel array 306 haves a plurality of data lines DL(1) to DL(M) and a plurality of pixels P, wherein M is a positive integer. Correspondingly, eight data buses DB(1) to DB(8) and eight data lines DL(1) to DL(8) are illustrated in FIG. 4A. The eight data lines DL(1) to DL(8) are sequentially disposed, in parallel, from a first side of the pixel array 306 to a second side of the pixel array 306 opposite to the first side. Two ends of each of the data lines DL(1) to DL(8) respectively extend to opposite third and fourth sides of the pixel array 306. Each pixel P is electrically coupled to a corresponding data line DL.

The drive circuit 304 is disposed aside the second side of the pixel array 306 such that an area of a lower glass substrate edge in a vertical direction can be reduced when the pixel array 306 is disposed on the lower glass substrate (not shown). Eight output terminals X(1) to X(8) are sequentially disposed at a side of the drive circuit 304 corresponding to the second side of the pixel array 306.

As shown in FIG. 4A, first ends of the data buses DB(1) to DB(4) are electrically coupled to the corresponding data lines DL(1) to DL(4) at the third side of the pixel array 306, and first ends of the other data buses DB(5) to DB(8) are electrically coupled to the data lines DL(5) to DL(8) at the fourth side of the pixel array 306. In this embodiment, one portion of the output terminals X closer to the third side is coupled to the data lines DL closer to the first side of the pixel array 306. For example, compared to the output terminal X(3), the output terminal X(2) is coupled to the data line DL(2) closer to the first side of the pixel array 306. The other portion of the output terminals X closer to the fourth side is coupled to the data line DL closer to the first side of the pixel array 306. For example, compared to the output terminal X(6), the output terminal X(7) is coupled to the data line DL(6) closer to the first side of the pixel array 306. Consequently, the eight data buses DB(1) to DB(8) are respectively disposed at two sides of the pixel array 306 so that the area, in which the data buses DB are disposed on the display panel (not shown), can be reduced, and the capacitance effect produced by the cross over phenomenon of the data buses may be solved.

FIG. 4B is a timing chart showing control signals according to the first embodiment of the invention. According to the new timing controlling method of the invention, the order of enabling the control signals C(1) to C(8) is from C(1) to C(2) . . . C(4), C(8), C(7) . . . C(5). Consequently, the data lines DL(1) to DL(4) of the liquid crystal display device 300 are electrically coupled to the corresponding output terminals X(1) to X(4) at the third side of the pixel array 306. The other data lines DL(5) to DL(8) are electrically coupled to the corresponding output terminals X(5) to X(8) at the fourth side of the pixel array 306, as shown in FIG. 4A.

### Second Embodiment

FIG. 5A is a schematic illustration showing a liquid crystal display device according to a second embodiment of the invention. The thin film transistor display device may be, for example, a liquid crystal display device 500. The internal elements of the liquid crystal display device 500 are almost the same as those of the liquid crystal display device 300 of the first embodiment. The liquid crystal display device 500 has a drive circuit 504, a pixel array 506 and a plurality of data buses DB. The pixel array 506 has a plurality of data lines DL(1) to DL(M) and a plurality of pixels P, wherein M is a positive integer. Correspondingly, eight data buses DB(1) to DB(8) and eight data lines DL(1) to DL(8) are illustrated in FIG. 5A. The data lines DL(1) to DL(8) are sequentially disposed, in parallel, from a first side of the pixel array 506 to a second side of the pixel array 506 opposite to the first side. Two ends of each of the data lines DL(1) to DL(8) respectively extend to opposite third and fourth sides of the pixel array 506. Each pixel P is respectively electrically coupled to the corresponding data line DL.

The drive circuit 504 is disposed aside the second side of the pixel array 506 such that an area of a lower glass substrate edge in a vertical direction can be reduced when the pixel array 506 is disposed on the lower glass substrate (not shown). Eight output terminals X(1) to X(8) are sequentially disposed at a side of the drive circuit 504 corresponding to the second side of the pixel array 506.

As shown in FIG. 5A, first ends of the data buses DB(1) to DB(4) are electrically coupled to the corresponding data lines DL(1), DL(3), DL(5) and DL(7) at the third side of the pixel array 506, and first ends of the other data buses DB(5) to DB(8) are electrically coupled to the corresponding data lines DL(2), DL(4), DL(6) and DL(8) at the fourth side of the pixel array 506. In this embodiment, one portion of the output terminals X closer to the third side is coupled to the data lines DL closer to the first side of the pixel array 506. For example, compared to the output terminal X(3), the output terminal X(2) is coupled to the data line DL(3) closer to the first side of the pixel array 506. The other portion of the output terminals X closer to the fourth side is coupled to the data lines DL closer to the first side of the pixel array 506. For example, compared to the output terminal X(6), the output terminal X(7) is coupled to the data line DL(6) closer to the first side of the pixel array 506. Consequently, the eight data buses DB(1) to DB(8) are respectively disposed at two sides of the pixel array 506 so that the area, in which the data buses DB are disposed on the display panel(not shown), can be reduced, and the capacitance effect produced by the cross over phenomenon of the data buses may be solved.

FIG. 5B is a timing chart showing control signals according to the second embodiment of the invention. According to the new timing controlling method of the invention, the order of enabling the control signals C(1) to C(8) is from C(1) to C(8), C(2), C(7), C(3), C(6) . . . . Consequently, the odd numbered data lines DL(1), DL(3), DL(5) and DL(7) of the liquid crystal display device 500 are electrically coupled to the corresponding output terminals X(1) to X(4) at the third side of the pixel array 506. The other even numbered data lines DL(2), DL(4), DL(6) and DL(8) are electrically coupled to the corresponding output terminals X(5) to X(8) at the fourth side of the pixel array 506, as shown in FIG. 5A.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A thin film transistor display device, comprising:
a pixel array having:
a plurality of data lines sequentially disposed, in parallel, from a first side of the pixel array to a second side opposite to the first side of the pixel array, wherein two ends of each of the data lines extend to a third side of the pixel array and a fourth side of the pixel array opposite to the third side of the pixel array, respectively; and
a plurality of pixels electrically coupled to the data lines, respectively;
a plurality of data buses, wherein first ends of one portion of the data buses are electrically coupled to one corresponding portion of the data lines at the third side of the pixel array, and first ends of the other portion of the data buses are electrically coupled to the other corresponding portion of the data lines at the fourth side of the pixel array; and
a drive circuit for sequentially receiving a plurality of image data and thus driving the pixels, the drive circuit having:
a plurality of output terminals electrically coupled to second ends of the data buses, wherein the drive circuit transforms the image data into a plurality of pixel voltages and then outputs the image data from the corresponding output terminals according to an arrangement relationship between the output terminals and the data lines.

2. The device according to claim 1, wherein the drive circuit further has:
a plurality of first latch units, wherein the drive circuit respectively stores the image data into the corresponding first latch units according to the arrangement relationship between the output terminals and the data lines;
a plurality of second latch units, electrically coupled to the plurality of first latch units respectively, for receiving the image data stored in the first latch units; and
a plurality of digital-to-analog converting units, electrically coupled to the plurality of second latch units and the output terminals respectively, for receiving the image data stored in the second latch units and transforming the image data into the pixel voltages and then outputting the pixel voltages from the corresponding output terminals.

3. The device according to claim 2, wherein the data lines have M data lines DL(1) to DL(M), the output terminals have N output terminals X(1) to X(N), where M and N are positive integers, one portion of the data lines DL(1) to DL(M/2) is electrically coupled to the corresponding output terminals X(1) to X(N/2) at the third side of the pixel array, and the other portion of the data lines DL(M/2+1) to DL(M) is electrically coupled to the corresponding output terminals X(N) to X(N/2+1) at the fourth side of the pixel array.

4. The device according to claim 3, wherein the first latch units have N first latch units L₁(1) to L₁(N) for respectively receiving control signals C(1) to C(N), the corresponding first latch units L₁ store the received image data when the control signals C(1) to C(N) are enabled respectively, and the control signals C(1) to C(N) are enabled in an order from C(1) to C(2) . . . C(N/2), C(N), C(N−1) . . . C(N/2+1) according to the arrangement relationship between the output terminals X(1) to X(N) and the data lines DL(1) to DL(M).

5. The device according to claim 2, wherein the data lines have M data lines DL(1) to DL(M), the output terminals have N output terminals X(1) to X(N), where M and N are positive integers, the odd numbered data lines DL(1), DL(3), DL(5) . . . are electrically coupled to the corresponding output terminals X(1) to X(N/2) at the third side of the pixel array, the even numbered data lines DL(2), DL(4), DL(6) . . . are electrically coupled to the corresponding output terminals X(N) to X(N/2+1) at the fourth side of the pixel array.

6. The device according to claim 5, wherein the first latch units have N first latch units L₁(1) to L₁(N) for respectively receiving control signals C(1) to C(N), the corresponding first latch units L₁ store the received image data when the control signals C(1) to C(N) are enabled respectively, and the control signals C(1) to C(N) are enabled in an order from C(1) to C(N), C(2), C(N−1), C(3), C(N−2) . . . according to the arrangement relationship between the output terminals X(1) to X(N) and the data lines DL(1) to DL(M).
